(19) United States
(12) Patent Application Publication
(10) Pub. No.: US 2022/0245435 A1
(43) Pub. Date: Aug. 4, 2022

(54) NEURAL NETWORK ACCELERATOR

(71) Applicant: NXP B.V., Eindhoven (NL)

(72) Inventors: Mahesh CHANDRA, Ghaziabad (IN); Rajkumar Agrawal, Noida (IN)

(21) Appl. No.: 17/161,123

(22) Filed: Jan. 28, 2021

(51) Int. Cl. G06N 3/063; G06N 3/04; G06F 9/50; G06F 7/544

(52) U.S. Cl. CPC G06N 3/063; G06F 7/5443; G06F 9/5027; G06N 3/0481

(57) ABSTRACT

A neural network accelerator includes an activation circuit that includes a processor and a selection circuit. The processor is configured to execute processing functions to generate processed signals. The selection circuit and the processor are collectively configured to execute various activation functions one at a time. To execute each activation function, the selection circuit is further configured to receive an input signal, processed signals, modified processed signals, constant signals, and a mode signal. The mode signal indicates an activation function that is to be executed. Further, the selection circuit is configured to output, based on the mode signal, a functional output signal that is one of the input signal, a processed signal, a modified processed signal, and a constant signal.

### BACKGROUND

The present disclosure relates generally to electronic circuits, and, more particularly, to a neural network accelerator.

A neural network accelerator is a specialized hardware accelerator that is designed to implement artificial intelligence applications such as artificial neural networks and recurrent neural networks. The neural network accelerator is configured to execute various activation functions that are based on applications performed by the neural network accelerator. An activation circuit is a basic building block of the neural network accelerator, and is designed to execute a single activation function. As a single activation circuit of a conventional neural network accelerator is incapable of executing various activation functions, various activation circuits are implemented in the conventional neural network accelerator. Thus, conventional neural network accelerators are large in size and consume high power. Hence, there is a need for a technical solution that solves the aforementioned problems of the conventional neural network accelerators.

### SUMMARY

In one embodiment, a neural network accelerator is disclosed. The neural network accelerator comprises an activation circuit that includes a processor and a selection circuit coupled with the processor. The processor is configured to execute a plurality of processing functions to generate a plurality of processed signals. The selection circuit and the processor are collectively configured to execute each activation function of a plurality of activation functions one at a time. The execution of each activation function corresponds to the execution of at least one processing function of the plurality of processing functions. To execute each activation function, the selection circuit is further configured to receive a first input signal, a first set of processed signals of the plurality of processed signals, a modified second set of processed signals, a set of constant signals, and a mode signal. The mode signal indicates an activation function of the plurality of activation functions that is to be executed. Further, the selection circuit is configured to output, based on the mode signal, one of the first input signal, a first processed signal of the first set of processed signals, a modified second processed signal of the modified second set of processed signals, and a first constant signal of the set of constant signals as a functional output signal.

In another embodiment, a method of executing a plurality of activation functions by a neural network accelerator is disclosed. The method includes executing, by a processor of an activation circuit of the neural network accelerator, a plurality of processing functions to generate a plurality of processed signals. The method further includes receiving, by a selection circuit of the activation circuit, an input signal, a first set of processed signals of the plurality of processed signals, a modified second set of processed signals, a set of constant signals, and a mode signal. The method further includes executing, collectively by the processor and the selection circuit based on the mode signal, each activation function of the plurality of activation functions one at a time to output one of the input signal, a first processed signal of the first set of processed signals, a modified second processed signal of the modified second set of processed signals, and a first constant signal of the set of constant signals as a functional output signal. The execution of each activation function corresponds to the execution of at least one processing function of the plurality of processing functions. The mode signal indicates an activation function of the plurality of activation functions that is to be executed.

In yet another embodiment, an activation circuit of a neural network accelerator is disclosed. The activation circuit includes a signal generator, a processor, and a selection circuit coupled with the processor and the signal generator. The signal generator is configured to receive a mode signal and decode the mode signal to generate a plurality of select signals. The mode signal indicates execution of an activation function of a plurality of activation functions. The processor is configured to execute a plurality of processing functions to generate a plurality of processed signals. The selection circuit and the processor are collectively configured to execute each activation function of the plurality of activation functions one at a time. The execution of each activation function corresponds to the execution of at least one processing function of the plurality of processing functions. To execute each activation function of the plurality of activation functions, the selection circuit is further configured to receive an input signal, a first set of processed signals of the plurality of processed signals, a modified second set of processed signals, a set of constant signals, and the plurality of select signals. Further, the selection circuit is configured to output, based on a first set of select signals of the plurality of select signals, one of the input signal, a first processed signal of the first set of processed signals, a modified second processed signal of the modified second set of processed signals, and a first constant signal of the set of constant signals as a functional output signal.

In some embodiments, to execute the activation function, the selection circuit is further configured to provide, based on the mode signal, a plurality of control signals to the processor. Each control signal is one of the first input signal, a third processed signal of the first set of processed signals, a modified fourth processed signal of the modified second set of processed signals, and a second constant signal of the set of constant signals.

In some embodiments, the processor comprises a plurality of processing circuits. A first set of processing circuits of the plurality of processing circuits is configured to receive the first input signal, and execute a first set of processing functions of the plurality of processing functions to generate a third set of processed signals of the plurality of processed signals. A second set of processing circuits of the plurality of processing circuits is configured to receive at least one of a corresponding processed signal of the plurality of processed signals and a first set of control signals of the plurality of control signals, and execute a second set of processing functions of the plurality of processing functions to generate a fourth set of processed signals of the plurality of processed signals. A third set of processing circuits of the plurality of processing circuits is configured to receive a second set of control signals of the plurality of control signals, and execute a third set of processing functions of the plurality of processing functions to generate a fifth set of processed signals of the plurality of processed signals.

In some embodiments, the selection circuit comprises a first plurality of multiplexers. The first plurality of multiplexers are configured to receive the mode signal and at least one of the first input signal, a first subset of processed signals of the first set of processed signals, a modified second subset of processed signals of the modified second set of processed signals, and a first subset of constant signals of the set of constant signals. Each modified processed signal of the modified second subset of processed signals corresponds to one of a left-shifted version of a corresponding processed signal of the first subset of processed signals and a right-shifted version of the corresponding processed signal. Further, the first plurality of multiplexers are configured to output, based on the mode signal, the plurality of control signals. The first subset of processed signals includes the third processed signal, the modified second subset of processed signals includes the modified fourth processed signal, and the first subset of constant signals includes the second constant signal.

In some embodiments, the selection circuit comprises a second plurality of multiplexers. The second plurality of multiplexers are configured to receive the mode signal and at least one of the first input signal, a third subset of processed signals of the first set of processed signals, a modified fourth subset of processed signals of the modified second set of processed signals, and a second subset of constant signals of the set of constant signals. Each modified processed signal of the modified fourth subset of processed signals corresponds to a right-shifted version of a corresponding processed signal of a fifth subset of processed signals of the first set of processed signals. Further, the second plurality of multiplexers are configured to output, based on the mode signal, a plurality of multiplexed signals. Each multiplexed signal of the plurality of multiplexed signals is one of the first input signal, the first processed signal of the third subset of processed signals, the modified second processed signal of the modified fourth subset of processed signals, and the first constant signal of the second subset of constant signals.

In some embodiments, the plurality of processing functions include at least one of an absolute value function, an exponential function, a ternary arithmetic function, a division function, an addition function, a multiplication function, and a sign function.

In some embodiments, the plurality of activation functions include at least a sigmoid function, a hyperbolic tangent function, a swish function, a rectified linear unit function, a parametric rectified linear unit function, an exponential linear unit function, and a gaussian function.

In some embodiments, the selection circuit further comprises a third multiplexer that is coupled with the second plurality of multiplexers, and configured to receive the plurality of multiplexed signals and a fifth processed signal of the plurality of processed signals, and select and output, based on the fifth processed signal, a first multiplexed signal of the plurality of multiplexed signals as the functional output signal.

In some embodiments, the neural network accelerator further comprises a multiply and accumulate (MAC) circuit that is coupled with the activation circuit, and configured to receive a second plurality of input signals, execute a MAC operation on the second plurality of input signals to generate the first input signal, and provide the first input signal to the activation circuit.

In some embodiments, the neural network accelerator further comprises a controller that is coupled with the activation circuit, and configured to receive the functional output signal and generate a feature map based on the functional output signal.

In some embodiments, the neural network accelerator further comprises a configuration circuit that is coupled with the activation circuit, and configured to generate and provide the mode signal to the activation circuit.

Various embodiments of the present disclosure disclose a neural network accelerator that executes multiple activation functions. The neural network accelerator includes an activation circuit. The activation circuit is configured to execute multiple processing functions to generate processed signals. The activation circuit is further configured to execute the activation functions one at a time. The execution of each activation function corresponds to the execution of at least one processing function. To execute each activation function, the activation circuit is further configured to receive the input signal, a first set of processed signals, a modified second set of processed signals, a set of constant signals, and a mode signal. The mode signal indicates an activation function that is to be executed. Further, the activation circuit is configured to output, based on the mode signal, one of the first input signal, a first processed signal of the first set of processed signals, a modified second processed signal of the modified second set of processed signals, and a first constant signal of the set of constant signals.

Thus, a single activation circuit of the neural network accelerator of the present disclosure is capable of executing various activation functions. Hence, a need for implementing multiple activation circuits to execute various activation functions in the neural network accelerator is eliminated. As a result, a size and a power consumption of the neural network accelerator is significantly less than a conventional neural network accelerator that implements various activation circuits to execute various activation functions.

### BRIEF DESCRIPTION OF THE DRAWINGS

The following detailed description of the preferred embodiments of the present disclosure will be better understood when read in conjunction with the appended drawings. The present disclosure is illustrated by way of example, and not limited by the accompanying figures, in which like references indicate similar elements.

FIG. 1 is a schematic block diagram of a neural network accelerator in accordance with an embodiment of the present disclosure;

FIG. 2 is a schematic block diagram of an activation circuit of the neural network accelerator of FIG. 1 in accordance with an embodiment of the present disclosure;

FIG. 3 is a schematic block diagram of the activation circuit of the neural network accelerator of FIG. 1 in accordance with another embodiment of the present disclosure; and

FIGS. 4A and 4B, collectively, represent a flow chart that illustrates a method of executing a plurality of activation functions by the neural network accelerator of FIG. 1 in accordance with an embodiment of the present disclosure.

### DETAILED DESCRIPTION

The detailed description of the appended drawings is intended as a description of the currently preferred embodiments of the present disclosure, and is not intended to represent the only form in which the present disclosure may be practiced. It is to be understood that the same or equivalent functions may be accomplished by different embodiments that are intended to be encompassed within the spirit and scope of the present disclosure.

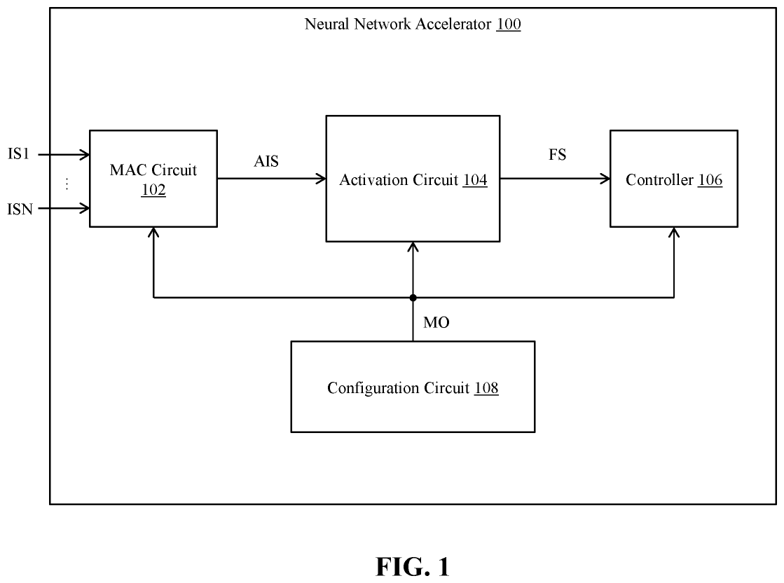

FIG. 1 is a schematic block diagram of a neural network accelerator 100 in accordance with an embodiment of the present disclosure. A neural network, such as an artificial neural network and a recurrent neural network, may include multiple layers. The neural network accelerator 100 may be implemented in an application specific integrated circuit (not shown). The neural network accelerator 100 includes a multiply and accumulate (MAC) circuit 102, an activation circuit 104, a controller 106, and a configuration circuit 108.

The MAC circuit 102 is coupled with the configuration circuit 108, and configured to receive a mode signal M0. The MAC circuit 102 is configured to receive a first plurality of input signals IS1, . . . , ISN of which first and Nth input signals IS1 and ISN are shown. In one example, when the neural network accelerator 100 is configured to implement a first layer of the neural network, a magnitude of each input signal of the first plurality of input signals IS1, . . . , ISN corresponds to a corresponding pixel value of an image (not shown). In another example, when the neural network accelerator 100 is configured to implement a second layer of the neural network, the first plurality of input signals IS1, . . . , ISN correspond to a feature map of the first layer of the neural network. The feature map is an output of the first layer obtained after application of a filter. The MAC circuit 102 may receive the first plurality of input signals IS1, . . . , ISN from an image sensor (not shown) or a memory (not shown) that is coupled with the neural network accelerator 100.

The MAC circuit 102 is further configured to execute a MAC operation on the first plurality of input signals IS1, . . . , ISN to generate a MAC output signal AIS (hereinafter referred to as a “activation input signal AIS”). To execute the MAC operation, the MAC circuit 102 is further configured to multiply the first plurality of input signals IS1, . . . , ISN with a plurality of weight values (not shown) that are stored in the MAC circuit 102, to generate a plurality of multiplied signals. In one embodiment, the plurality of weight values are based on the mode signal M0. Further, the MAC circuit 102 is configured to accumulate a magnitude of each multiplied signal of the plurality of multiplied signals to generate the activation input signal AIS. The MAC circuit 102 is further coupled with the activation circuit 104, and further configured to provide the activation input signal AIS to the activation circuit 104.

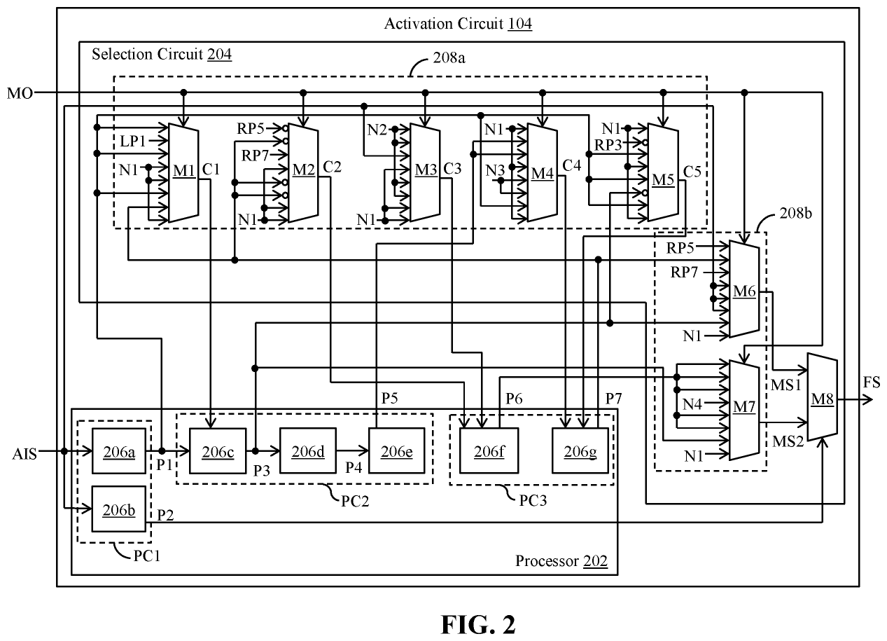

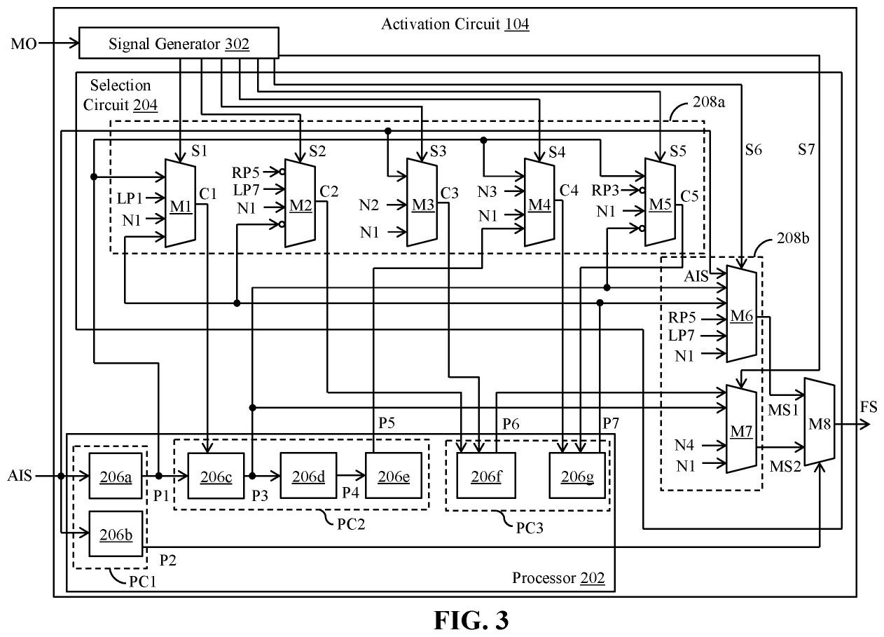

The activation circuit 104 is coupled with the MAC circuit 102, and configured to receive the activation input signal AIS. The activation circuit 104 is further configured to execute each activation function of a plurality of activation functions one at a time, on the activation input signal AIS to generate a functional output signal FS. The plurality of activation functions include at least a sigmoid function, a hyperbolic tangent (tan h) function, a swish function, a rectified linear unit (ReLU) function, a parametric rectified linear unit (PReLU) function, an exponential linear unit (ELU) function, and a gaussian function. The activation circuit 104 is further coupled with the configuration circuit 108 to receive the mode signal M0. The mode signal M0 indicates a corresponding activation function of the plurality of activation functions that is to be executed on the activation input signal AIS. In one example, the mode signal M0 indicates execution of the sigmoid function. In another example, the mode signal M0 indicates the execution of the tan h function. The structure and working of the activation circuit 104 are explained in detail in conjunction with FIGS. 2 and 3.

The controller 106 is coupled with the activation circuit 104 and the configuration circuit 108, and configured to receive the functional output signal FS and the mode signal M0, and generate a feature map (not shown) based on the functional output signal FS and the mode signal M0. In one example, based on the mode signal M0, the controller 106 is further configured to process the functional output signal FS to generate the feature map. The feature map is obtained on implementing a current layer of the neural network and may be utilized for various purposes. In one example, the feature map is utilized as an input for a subsequent layer of the neural network. In another example, the feature map is utilized for object detection and classification applications.

The configuration circuit 108 is coupled with the MAC circuit 102, the activation circuit 104, and the controller 106, and configured to generate and provide the mode signal M0 to the MAC circuit 102, the activation circuit 104, and the controller 106. The configuration circuit 108 generates the mode signal M0 to initiate the execution of the corresponding activation function of the plurality of activation functions by the activation circuit 104.

FIG. 2 is a schematic block diagram of the activation circuit 104 in accordance with an embodiment of the present disclosure. The activation circuit 104 includes a processor 202 and a selection circuit 204.

The processor 202 is coupled with the MAC circuit 102 and the selection circuit 204. The processor 202 is configured to receive the activation input signal AIS and a plurality of control signals C1-C5, and execute a plurality of processing functions to generate a plurality of processed signals P1-P7. The plurality of processing functions include at least one of an absolute value function, an exponential function, a ternary arithmetic function, a division function, an addition function, a multiplication function, and a sign function. The execution of each activation function of the plurality of activation functions corresponds to the execution of at least one processing function of the plurality of processing functions. The processor 202 further includes a plurality of processing circuits of which first through third sets of processing circuits PC1-PC3 are shown.

The first set of processing circuits PC1 includes first and second processing circuits 206a and 206b. The first set of processing circuits PC1 is configured to receive the activation input signal AIS, and execute a first set of processing functions of the plurality of processing functions to generate a first set of processed signals P1 and P2, i.e., first and second processed signals P1 and P2, of the plurality of processed signals P1-P7. The first set of processing functions includes the absolute value function and the sign function.

The first processing circuit 206a includes suitable circuitry that may be configured to perform one or more operations to execute the absolute value function. The first processing circuit 206a is configured to receive the activation input signal AIS, and execute the absolute value function on the activation input signal AIS to generate the first processed signal P1. To execute the absolute value function, the first processing circuit 206a is further configured to determine an absolute value, i.e., a magnitude, of the activation input signal AIS. The first processed signal P1 thus indicates the absolute value of the activation input signal AIS. The first processing circuit 206a is coupled with the selection circuit 204, and configured to provide the first processed signal P1 to the selection circuit 204.

The second processing circuit 206b includes suitable circuitry that may be configured to perform one or more operations to execute the sign function. The second processing circuit 206b is configured to receive the activation input signal AIS, and execute the sign function on the activation input signal AIS to generate the second processed signal P2. To execute the sign function, the second processing circuit 206b is further configured to determine whether an amplitude of the activation input signal AIS indicates a positive value or a negative value based on a logic state of the activation input signal AIS. In one example, when the amplitude of the activation input signal AIS indicates a positive value, the second processed signal P2 is generated at a logic low state, and when the amplitude of the activation input signal AIS indicates a negative value, the second processed signal P2 is generated at a logic high state.

The second set of processing circuits PC2 includes third through fifth processing circuits 206c-206e. The second set of processing circuits PC2 is configured to receive at least one of a corresponding processed signal, i.e., the first processed signal P1, of the plurality of processed signals P1-P7 and a first set of control signals, i.e., a first control signal C1, of the plurality of control signals C1-C5, and execute a second set of processing functions of the plurality of processing functions to generate a second set of processed signals P3-P5, i.e., third through fifth processed signals P3-P5, of the plurality of processed signals P1-P7. The second set of processing functions includes the exponential function, the ternary arithmetic function, and the division function.

The third processing circuit 206c includes suitable circuitry that may be configured to perform one or more operations to execute the exponential function. The third processing circuit 206c is configured to receive the first processed signal P1 and the first control signal C1, and execute the exponential function on at least one of the first processed signal P1 and the first control signal C1 to generate the third processed signal P3. The third processing circuit 206c is coupled with the selection circuit 204, and configured to provide the third processed signal P3 to the selection circuit 204. The exponential function is represented by an equation (1) given below:

Exponential function=e^{-x} (1)

where,
x represents a magnitude of one of the first processed signal P1 and the first control signal C1.

The fourth processing circuit 206d includes suitable circuitry that may be configured to perform one or more operations to execute the ternary arithmetic function. The fourth processing circuit 206d is configured to receive the third processed signal P3, and execute the ternary arithmetic function on the third processed signal P3 to generate the fourth processed signal P4. The ternary arithmetic function is represented by an equation (2) given below:

$$Ternary arithmetic function = \frac{( 1 + {e}^{- x} )}{2} \qquad ( 2 )$$

where,
e^{-x} represents a magnitude of the third processed signal P3.

The fifth processing circuit 206e includes suitable circuitry that may be configured to perform one or more operations to execute the division function. The fifth processing circuit 206e is configured to receive the fourth processed signal P4, and execute the division function on the fourth processed signal P4 to generate the fifth processed signal P5. To execute the division function, the fifth processing circuit 206e is further configured to determine a reciprocal of a magnitude of the fourth processed signal P4. The fifth processed signal P5 indicates the reciprocal of the magnitude of the fourth processed signal P4. In one example, the division function is executed based on a Newton Raphson method. The fifth processing circuit 206e is coupled with the selection circuit 204, and further configured to provide the fifth processed signal P5 to the selection circuit 204.

The third set of processing circuits PC3 includes sixth and seventh processing circuits 206f and 206g. The third set of processing circuits PC3 is configured to receive a second set of control signals, i.e., second through fifth control signals C2-C5, of the plurality of control signals C1-C5, and execute a third set of processing functions of the plurality of processing functions to generate a third set of processed signals P6 and P7, i.e., sixth and seventh processed signals P6 and P7 of the plurality of processed signals P1-P7.

The sixth processing circuit 206f includes suitable circuitry that may be configured to perform one or more operations to execute the addition function. The sixth processing circuit 206f is configured to receive the second and third control signals C2 and C3, and execute the addition function on the second and third control signals C2 and C3 to generate the sixth processed signal P6. The sixth processing circuit 206f is coupled with the selection circuit 204, and further configured to provide the sixth processed signal P6 to the selection circuit 204. The seventh processing circuit 206g includes suitable circuitry that may be configured to perform one or more operations to execute the multiplication function. The seventh processing circuit 206g is configured to receive the fourth and fifth control signals C4 and C5, and execute the multiplication function on the fourth and fifth control signals C4 and C5 to generate the seventh processed signal P7. The seventh processing circuit 206g is coupled with the selection circuit 204, and further configured to provide the seventh processed signal P7 to the selection circuit 204.

The selection circuit 204 is coupled with the processor 202. The selection circuit 204 and the processor 202 are collectively configured to execute each activation function of the plurality of activation functions one at a time. To execute each activation function, the selection circuit 204 is further configured to receive the activation input signal AIS, a fourth set of processed signals P1-P3 and P5-P7, i.e., the first, second, third, fifth, sixth, and seventh processed signals P1, P2, P3, P5, P6, and P7, a modified fifth set of processed signals LP1, RP3, RP5, and RP7, a set of constant signals N1-N4, i.e., first through fourth constant signals N1-N4, and the mode signal M0. The modified fifth set of processed signals LP1, RP3, RP5, and RP7 includes modified versions of the first, third, fifth, and seventh processed signals P1, P3, P5, and P7. In one embodiment, the modified fifth set of processed signals LP1, RP3, RP5, and RP7 is generated by a conversion circuit (not shown) of the activation circuit 104. A magnitude of each constant signal of the set of constant signals N1-N4 is constant. In one example, the first constant signal N1 indicates a “don't care” state, a magnitude of the second constant signal N2 corresponds to a constant value ‘1’, a magnitude of the third constant signal N3 corresponds to a constant value ‘a’, and a magnitude of the fourth constant signal N4 corresponds to a constant value ‘0’.

The selection circuit 204 is further configured to provide, based on the mode signal M0, the plurality of control signals C1-C5 to the processor 202 (i.e., the third, sixth, and seventh processing circuits 206c, 206f, and 206g). Each control signal is one of the activation input signal AIS, a corresponding processed signal of the fourth set of processed signals P1-P3 and P5-P7, a corresponding modified processed signal of the modified fifth set of processed signals LP1, RP3, RP5, and RP7, and a corresponding constant signal of the set of constant signals N1-N4. Further, the selection circuit 204 is configured to output, based on the mode signal M0, one of the activation input signal AIS, a corresponding processed signal of the fourth set of processed signals P1-P3 and P5-P7, a corresponding modified processed signal of the modified fifth set of processed signals LP1, RP3, RP5, and RP7, and a corresponding constant signal of the set of constant signals N1-N4 as the functional output signal FS. The selection circuit 204 includes a first plurality of multiplexers 208a that include first through fifth multiplexers M1-M5, a second plurality of multiplexers 208b that include sixth and seventh multiplexers M6 and M7, and an eighth multiplexer M8.

The first plurality of multiplexers 208a are configured to receive the mode signal M0 and at least one of the activation input signal AIS, a first subset of processed signals P1, P3, P5, and P7, i.e., the first, third, fifth, and seventh processed signals P1, P3, P5, and P7, of the fourth set of processed signals P1-P3 and P5-P7, a modified second subset of processed signals LP1, RP3, RP5, and RP7, i.e., the modified versions of the first, third, fifth, and seventh processed signals P1, P3, P5, and P7, of the modified fifth set of processed signals LP1, RP3, RP5, and RP7, and a first subset of constant signals N1-N3, i.e., the first through third constant signals N1-N3, of the set of constant signals N1-N4. Each modified processed signal of the modified second subset of processed signals LP1, RP3, RP5, and RP7 corresponds to one of a left-shifted version of a corresponding processed signal of the first subset of processed signals P1, P3, P5, and P7, and a right-shifted version of the corresponding processed signal. The modified second subset of processed signals LP1, RP3, RP5, and RP7 includes a left-shifted version of the first processed signal P1 (hereinafter referred to as a “left-shifted first processed signal LP1”), a right-shifted version of the third processed signal P3 (hereinafter referred to as a “right-shifted third processed signal RP3”), a right-shifted version of the fifth processed signal P5 (hereinafter referred to as a “right-shifted fifth processed signal RP5”), and a right-shifted version of the seventh processed signal P7 (hereinafter referred to as a “right-shifted seventh processed signal RP7”). Further, the first plurality of multiplexers 208a are configured to output, based on the mode signal M0, the plurality of control signals C1-C5 as explained herein.

The first multiplexer M1 is coupled with the configuration circuit 108 and the first and seventh processing circuits 206a and 206g, and configured to receive the mode signal M0, the first processed signal P1, the left-shifted first processed signal LP1, the first constant signal N1, and the seventh processed signal P7. The first multiplexer M1 receives the first processed signal P1, the left-shifted first processed signal LP1, the first constant signal N1, and the seventh processed signal P7 at non-inverting input terminals thereof, and the mode signal M0 at a select terminal thereof. Based on the mode signal M0, the first multiplexer M1 is further configured to select and output one of the first processed signal P1, the left-shifted first processed signal LP1, the first constant signal N1, and the seventh processed signal P7 as the first control signal C1 at an output terminal thereof. The first multiplexer M1 is further coupled with the third processing circuit 206c, and further configured to provide the first control signal C1 to the third processing circuit 206c.

The second multiplexer M2 is coupled with the configuration circuit 108 and the seventh processing circuit 206g, and configured to receive the mode signal M0, the right-shifted fifth processed signal RP5, the right-shifted seventh processed signal RP7, the seventh processed signal P7, and the first constant signal N1. The second multiplexer M2 receives the right-shifted seventh processed signal RP7 and the first constant signal N1 at non-inverting input terminals thereof, and the mode signal M0 at a select terminal thereof. Further, the second multiplexer M2 receives the right-shifted fifth processed signal RP5 and the seventh processed signal P7 at inverting input terminals thereof such that the second multiplexer M2 thus receives a bitwise inverted version of the right-shifted fifth processed signal RP5 and the seventh processed signal P7. Based on the mode signal M0, the second multiplexer M2 is further configured to select and output one of the bitwise inverted version of the right-shifted fifth processed signal RP5, the right-shifted seventh processed signal RP7, the bitwise inverted version of the seventh processed signal P7, and the first constant signal N1 as the second control signal C2 at an output terminal thereof. The second multiplexer M2 is further coupled with the sixth processing circuit 206f, and further configured to provide the second control signal C2 to the sixth processing circuit 206f.

The third multiplexer M3 is coupled with the configuration circuit 108, and configured to receive the mode signal M0, the activation input signal AIS, and the first and second constant signals N1 and N2. The third multiplexer M3 receives the activation input signal AIS and the first and second constant signals N1 and N2 at non-inverting input terminals thereof, and the mode signal M0 at a select terminal thereof. Based on the mode signal M0, the third multiplexer M3 is further configured to select and output one of the activation input signal AIS and the first and second constant signals N1 and N2 as the third control signal C3 at an output terminal thereof. The third multiplexer M3 is further coupled with the sixth processing circuit 206f, and further configured to provide the third control signal C3 to the sixth processing circuit 206f.

The fourth multiplexer M4 is coupled with the configuration circuit 108 and the first and fifth processing circuits 206a and 206e, and configured to receive the mode signal M0, the first and fifth processed signals P1 and P5, and the first and third constant signals N1 and N3. The fourth multiplexer M4 receives the first and fifth processed signals P1 and P5 and the first and third constant signals N1 and N3 at non-inverting input terminals thereof, and the mode signal M0 at a select terminal thereof. Based on the mode signal M0, the fourth multiplexer M4 is further configured to select and output one of the first and fifth processed signals P1 and P5 and the first and third constant signals N1 and N3 as the fourth control signal C4 at an output terminal thereof. The fourth multiplexer M4 is further coupled with the seventh processing circuit 206g, and further configured to provide the fourth control signal C4 to the seventh processing circuit 206g.

The fifth multiplexer M5 is coupled with the configuration circuit 108 and the first and third processing circuits 206a and 206c, and configured to receive the mode signal M0, the first and third processed signals P1 and P3, the right-shifted third processed signal RP3, and the first constant signal N1. The fifth multiplexer M5 receives the first processed signal P1 and the first constant signal N1 at non-inverting input terminals thereof, and the mode signal M0 at a select terminal thereof. Further, the fifth multiplexer M5 receives the third processed signal P3 and the right-shifted third processed signal RP3 at inverting input terminals thereof such that the fifth multiplexer M5 thus receives a bitwise inverted version of the third processed signal P3 and the right-shifted third processed signal RP3. Based on the mode signal M0, the fifth multiplexer M5 is further configured to select and output one of the first processed signal P1, the bitwise inverted version of the third processed signal P3, the bitwise inverted version of the right-shifted third processed signal RP3, and the first constant signal N1 as the fifth control signal C5 at an output terminal thereof. The fifth multiplexer M5 is further coupled with the seventh processing circuit 206g, and further configured to provide the fifth control signal C5 to the seventh processing circuit 206g.

The second plurality of multiplexers 208b are configured to receive the mode signal M0 and at least one of the activation input signal AIS, a third subset of processed signals P3, P6, and P7, i.e., the third, sixth, and seventh processed signals P3, P6, and P7, of the fourth set of processed signals P1-P3 and P5-P7, a modified fourth subset of processed signals RP5 and RP7 of the modified fifth set of processed signals LP1, RP3, RP5, and RP7, and a second subset of constant signals N1 and N4, i.e., the first and fourth constant signals N1 and N4, of the set of constant signals N1-N4. Each modified processed signal of the modified fourth subset of processed signals RP5 and RP7 corresponds to a right-shifted version of a corresponding processed signal of a fifth subset of processed signals P1 and P7 of the fourth set of processed signals P1-P3 and P5-P7. The modified fourth subset of processed signals RP5 and RP7 further includes the right-shifted fifth processed signal RP5 and the right-shifted seventh processed signal RP7.

The second plurality of multiplexers 208b are further configured to output, based on the mode signal M0, a plurality of multiplexed signals, such as first and second multiplexed signals MS1 and MS2. Each multiplexed signal of the plurality of multiplexed signals is one of the activation input signal AIS, a corresponding processed signal of the third subset of processed signals P3, P6, and P7, a corresponding modified processed signal of the modified fourth subset of processed signals RP5 and RP7, and a corresponding constant signal of the second subset of constant signals N1 and N4.

The sixth multiplexer M6 is coupled with the configuration circuit 108 and the third and seventh processing circuits 206c and 206g, and configured to receive the mode signal M0, the activation input signal AIS, the third and seventh processed signals P3 and P7, the right-shifted fifth processed signal RP5, the right-shifted seventh processed signal RP7, and the first constant signal N1. The sixth multiplexer M6 receives the activation input signal AIS, the third and seventh processed signals P3 and P7, the right-shifted fifth processed signal RP5, the right-shifted seventh processed signal RP7, and the first constant signal N1 at non-inverting input terminals thereof, and the mode signal M0 at a select terminal thereof. Based on the mode signal M0, the sixth multiplexer M6 is further configured to select and output one of the activation input signal AIS, the third and seventh processed signals P3 and P7, the right-shifted fifth processed signal RP5, the right-shifted seventh processed signal RP7, and the first constant signal N1 as the first multiplexed signal AIS1 at an output terminal thereof. The sixth multiplexer M6 is further coupled with the eighth multiplexer M8, and further configured to provide the first multiplexed signal AIS1 to the eighth multiplexer M8.

The seventh multiplexer M7 is coupled with the configuration circuit 108 and the third and sixth processing circuits 206c and 206f, and configured to receive the mode signal M0, the third and sixth processed signals P3 and P6, and the first and fourth constant signals N1 and N4. The seventh multiplexer M7 receives the third and sixth processed signals P3 and P6 and the first and fourth constant signals N1 and N4 at non-inverting input terminals thereof, and the mode signal M0 at a select terminal thereof. Based on the mode signal M0, the seventh multiplexer M7 is further configured to select and output one of the third and sixth processed signals P3 and P6, and the first and fourth constant signals N1 and N4 as the second multiplexed signal AIS2 at an output terminal thereof. The seventh multiplexer M7 is further coupled with the eighth multiplexer M8, and further configured to provide the second multiplexed signal AIS2 to the eighth multiplexer M8.

The eighth multiplexer M8 is coupled with the second plurality of multiplexers 208b (i.e., the sixth and seventh multiplexers M6 and M7) and the second processing circuit 206b, and configured to receive the plurality of multiplexed signals (i.e., the first and second multiplexed signals MS1 and MS2) and the second processed signal P2. The eighth multiplexer M8 receives the first and second multiplexed signals MS1 and MS2 at non-inverting input terminals thereof, and the second processed signal P2 at a select terminal thereof. Based on the second processed signal P2, the eighth multiplexer M8 is further configured to select and output one of the first and second multiplexed signals MS1 and MS2 as the functional output signal FS at an output terminal thereof. In one embodiment, each of the first through seventh multiplexers M1-M7 is an 8:1 multiplexer and the eighth multiplexer M8 is a 2:1 multiplexer.

In operation, the MAC circuit 102 generates the activation input signal AIS and the configuration circuit 108 generates the mode signal M0 to initiate the execution of the plurality of activation functions by the activation circuit 104. In one embodiment, the mode signal M0 is a 3-bit digital signal and the configuration circuit 108 generates the mode signal M0 multiple times with different values. The activation circuit 104 receives the mode signal M0 and the activation input signal AIS and executes multiple activation functions one at a time. In one example, when the mode signal M0 is ‘000’, the activation circuit 104 executes the sigmoid function. The sigmoid function is represented by an equation (3) given below:

$$sigmoid ( a ) = \{ \begin{matrix}1 - \frac{1}{1 + {e}^{- a b s ( a )}} , a < 0 \\ \frac{1}{1 + {e}^{- a b s ( a )}} , a \geq 0\end{matrix} \} \qquad ( 3 )$$

where,
a represents a magnitude of the activation input signal AIS, and
abs(a) represents an absolute value of the activation input signal AIS.

To execute the sigmoid function, the first and second processing circuits 206a and 206b receive the activation input signal AIS and generate the first and second processed signals P1 and P2, respectively, such that the first processed signal P1 represents ‘abs(a)’. The first multiplexer M1 selects and outputs, based on the mode signal M0, the first processed signal P1 as the first control signal C1. The third processing circuit 206c receives the first processed signal P1 and the first control signal C1, and generates the third processed signal P3 such that the third processed signal P3 represents ‘e^{-abs(a)}’. The fourth processing circuit 206d receives the third processed signal P3 and generates the fourth processed signal P4 such that the fourth processed signal P4 represents ‘(1+e^{-abs(a)}/2’. The fifth processing circuit 206e receives the fourth processed signal P4 and generates the fifth processed signal P5 such that the fifth processed signal P5 represents ‘2/(1+e^{-abs(a)})’.

The second multiplexer M2 selects and outputs, based on the mode signal M0, the bitwise inverted version of the right-shifted fifth processed signal RP5 as the second control signal C2. As the second multiplexer M2 receives the right-shifted fifth processed signal RP5 at the inverting terminal of the second multiplexer M2, the second control signal C2 represents ‘−(1/(1+e^{-abs(a)}))’. The third multiplexer M3 selects and outputs, based on the mode signal M0, the second constant signal N2 as the third control signal C3. Thus, the third control signal C3 represents ‘1’. The sixth processing circuit 206f receives the second and third control signals C2 and C3 and generates the sixth processed signal P6 such that the sixth processed signal P6 represents ‘1−(1/(1+e^{-abs(a)}))’. The fourth and fifth multiplexers M4 and M5 select and output, based on the mode signal M0, the first constant signal N1 as the fourth and fifth control signals C4 and C5, respectively. The seventh processing circuit 206g receives the fourth and fifth control signals C4 and C5 and generates the seventh processed signal P7.

The sixth multiplexer M6 selects and outputs, based on the mode signal M0, the right-shifted fifth processed signal RP5 as the first multiplexed signal AIS1. Thus, the first multiplexed signal AIS1 represents ‘1/(1+e^{-abs(a)})’. The seventh multiplexer M7 selects and outputs, based on the mode signal M0, the sixth processed signal P6 as the second multiplexed signal AIS2. Thus, the second multiplexed signal AIS2 represents ‘1−(1/(1+e^{-abs(a)}))’. The eighth multiplexer M8 selects and outputs, based on the second processed signal P2, one of the first and second multiplexed signals MS1 and MS2 as the functional output signal FS. When the second processed signal P2 is generated at logic low state, the eighth multiplexer M8 selects and outputs the first multiplexed signal AIS1 as the functional output signal FS. Thus, the functional output signal FS represents ‘1/(1+e^{-abs(a)})’. When the second processed signal P2 is generated at logic high state, the eighth multiplexer M8 selects and outputs the second multiplexed signal AIS2 as the functional output signal FS. Thus, the functional output signal FS represents ‘1−(1/(1+e^{-abs(a)}))’. Thus, the processor 202 and the selection circuit 204 collectively execute the sigmoid function.

When the mode signal M0 is ‘001’, the activation circuit 104 executes the tan h function. The tan h function is represented by an equation (4) given below:

$$tanh ( a ) = \{ \begin{matrix}- \frac{1 - {e}^{- ab s ( 2 a )}}{1 + {e}^{- a bs ( 2 a )}} , a < 0 \\ \frac{1 - {e}^{- ab s ( 2 a )}}{1 + {e}^{- a bs ( 2 a )}} , a \geq 0\end{matrix} \} \qquad ( 4 )$$

To execute the tan h function, the first and second processing circuits 206a and 206b receive the activation input signal AIS and generate the first and second processed signals P1 and P2, respectively, such that the first processed signal P1 represents ‘abs(a)’. The first multiplexer M1 selects and outputs, based on the mode signal M0, the left-shifted first processed signal LP1 as the first control signal C1. Thus, the first control signal C1 represents ‘abs(2a)’. The third processing circuit 206c receives the first processed signal P1 and the first control signal C1, and generates the third processed signal P3 such that the third processed signal P3 represents ‘e^{-abs(2a)}’. The fourth processing circuit 206d receives the third processed signal P3 and generates the fourth processed signal P4 such that the fourth processed signal P4 represents ‘(1+e^{-abs(2a)})/2’. The fifth processing circuit 206e receives the fourth processed signal P4 and generates the fifth processed signal P5 such that the fifth processed signal P5 represents ‘2/(1+e^{-abs(2a)})’.

The fourth multiplexer M4 selects and outputs, based on the mode signal M0, the fifth processed signal P5 as the fourth control signal C4. Thus, the fourth control signal C4 represents ‘2/(1+e^{-abs(2a)})’. The fifth multiplexer M5 selects and outputs, based on the mode signal M0, the bitwise inverted version of the right-shifted third processed signal RP3 as the fifth control signal C5. As the fifth multiplexer M5 receives the right-shifted third processed signal RP3 at the inverting terminal of the fifth multiplexer M5, the fifth control signal C5 represents ‘(1−e^{-abs(2a)})/2’. The seventh processing circuit 206g receives the fourth and fifth control signals C4 and C5 and generates the seventh processed signal P7 such that the seventh processed signal P7 represents ‘(1−e^{-abs(2a)})/(1+e^{-abs(2a)})’.

The second multiplexer M2 selects and outputs, based on the mode signal M0, the bitwise inverted version of the seventh processed signal P7 as the second control signal C2. As the second multiplexer M2 receives the seventh processed signal P7 at the inverting terminal of the second multiplexer M2, the second control signal C2 represents ‘−((1−e^{-abs(2a)})/(1+e^{-abs(2a)}))’. The third multiplexer M3 selects and outputs, based on the mode signal M0, the second constant signal N2 as the third control signal C3. Thus, the third control signal C3 represents ‘1’. The sixth processing circuit 206f receives the second and third control signals C2 and C3 and generates the sixth processed signal P6 such that the sixth processed signal P6 represents ‘−((1−e^{-abs(2a)})/(1+e^{-abs(2a)}))’.

The sixth multiplexer M6 selects and outputs, based on the mode signal M0, the seventh processed signal P7 as the first multiplexed signal AIS1. Thus, the first multiplexed signal AIS1 represents ‘−((1−e^{-abs(2a)})/(1+e^{-abs(2a)}))’. The seventh multiplexer M7 selects and outputs, based on the mode signal M0, the sixth processed signal P6 as the second multiplexed signal AIS2. Thus, the second multiplexed signal AIS2 represents ‘−((1−e^{-abs(2a)})/(1+e^{-abs(2a)}))’. The eighth multiplexer M8 selects and outputs, based on the second processed signal P2, one of the first and second multiplexed signals MS1 and MS2 as the functional output signal FS. When the second processed signal P2 is generated at logic low state, the eighth multiplexer M8 selects and outputs the first multiplexed signal AIS1 as the functional output signal FS. Thus, the functional output signal FS represents ‘−((1−e^{-abs(2a)})/(1+e^{-abs(2a)}))’. When the second processed signal P2 is generated at logic high state, the eighth multiplexer M8 selects and outputs the second multiplexed signal AIS2 as the functional output signal FS. Thus, the functional output signal FS represents ‘−((1−e^{-abs(2a)})/(1+e^{-abs(2a)}))’. Thus, the processor 202 and the selection circuit 204 collectively execute the tan h function.

When the mode signal M0 is ‘010’, the activation circuit 104 executes the swish function. The swish function is represented by an equation (5) given below:

$$swish ( a ) = \{ \begin{matrix}\frac{abs ( a )}{1 + {e}^{- a b s ( a )}} + a , a < 0 \\ \frac{abs ( a )}{1 + {e}^{- a b s ( a )}} , a \geq 0\end{matrix} \} \qquad ( 5 )$$

To execute the swish function, the first and second processing circuits 206a and 206b receive the activation input signal AIS and generate the first and second processed signals P1 and P2, respectively, such that the first processed signal P1 represents ‘abs(a)’. The first multiplexer M1 selects and outputs, based on the mode signal M0, the first processed signal P1 as the first control signal C1. Thus, the first control signal C1 represents ‘abs(a)’. The third processing circuit 206c receives the first processed signal P1 and the first control signal C1, and generates the third processed signal P3 such that the third processed signal P3 represents ‘e^{-abs(a)}’. The fourth processing circuit 206d receives the third processed signal P3 and generates the fourth processed signal P4 such that the fourth processed signal P4 represents ‘(1+e^{-abs(a)})/2’. The fifth processing circuit 206e receives the fourth processed signal P4 and generates the fifth processed signal P5 such that the fifth processed signal P5 represents ‘2/(1+e^{-abs(a)})’.

The fourth multiplexer M4 selects and outputs, based on the mode signal M0, the fifth processed signal P5 as the fourth control signal C4. Thus, the fourth control signal C4 represents ‘2/(1+e^{-abs(a)})’. The fifth multiplexer M5 selects and outputs, based on the mode signal M0, the first processed signal P1 as the fifth control signal C5. Thus, the fifth control signal C5 represents ‘abs(a)’. The seventh processing circuit 206g receives the fourth and fifth control signals C4 and C5 and generates the seventh processed signal P7 such that the seventh processed signal P7 represents ‘(2*abs(a))/(1+e^{-abs(a)})’.

The second multiplexer M2 selects and outputs, based on the mode signal M0, the right-shifted seventh processed signal RP7 as the second control signal C2. Thus, the second control signal C2 represents ‘abs(a)/(1+e^{-abs(a)})’. The third multiplexer M3 selects and outputs, based on the mode signal M0, the activation input signal AIS as the third control signal C3. Thus, the third control signal C3 represents ‘a’. The sixth processing circuit 206f receives the second and third control signals C2 and C3 and generates the sixth processed signal P6 such that the sixth processed signal P6 represents ‘(abs(a)/(1+e^{-abs(a)}))+a’.

The sixth multiplexer M6 selects and outputs, based on the mode signal M0, the right-shifted seventh processed signal RP7 as the first multiplexed signal AIS1. Thus, the first multiplexed signal AIS1 represents ‘abs(a)/(1+e^{-abs(a)})’. The seventh multiplexer M7 selects and outputs, based on the mode signal M0, the sixth processed signal P6 as the second multiplexed signal AIS2. Thus, the second multiplexed signal AIS2 represents ‘(abs(a)/(1+e^{-abs(a)}))+a’. The eighth multiplexer M8 selects and outputs, based on the second processed signal P2, one of the first and second multiplexed signals MS1 and MS2 as the functional output signal FS. When the second processed signal P2 is generated at logic low state, the eighth multiplexer M8 selects and outputs the first multiplexed signal AIS1 as the functional output signal FS. Thus, the functional output signal FS represents ‘abs(a)/(1+e^{-abs(a)}’. When the second processed signal P2 is generated at logic high state, the eighth multiplexer M8 selects and outputs the second multiplexed signal AIS2 as the functional output signal FS. Thus, the functional output signal FS represents ‘(abs(a)/(1+e^{-abs(a)}))+a’. Thus, the processor 202 and the selection circuit 204 collectively execute the swish function.

When the mode signal M0 is ‘011’, the activation circuit 104 executes the ReLU function. The ReLU function is represented by an equation (6) given below:

$$ReLU ( a ) = \{ \begin{matrix}0 , & a < 0 \\ a , & a \geq 0\end{matrix} \} \qquad ( 6 )$$

To execute the ReLU function, the first and second processing circuits 206a and 206b receive the activation input signal AIS and generate the first and second processed signals P1 and P2, respectively. The first multiplexer M1 selects and outputs, based on the mode signal M0, the first constant signal N1 as the first control signal C1. The third processing circuit 206c receives the first processed signal P1 and the first control signal C1, and generates the third processed signal P3. The fourth processing circuit 206d receives the third processed signal P3 and generates the fourth processed signal P4. The fifth processing circuit 206e receives the fourth processed signal P4 and generates the fifth processed signal P5.

The second and third multiplexers M2 and M3 select and output, based on the mode signal M0, the first constant signal N1 as the second and third control signals C2 and C3, respectively. The sixth processing circuit 206f receives the second and third control signals C2 and C3 and generates the sixth processed signal P6. The fourth and fifth multiplexers M4 and M5 select and output, based on the mode signal M0, the first constant signal N1 as the fourth and fifth control signals C4 and C5, respectively. The seventh processing circuit 206g receives the fourth and fifth control signals C4 and C5 and generates the seventh processed signal P7.

The sixth multiplexer M6 selects and outputs, based on the mode signal M0, the activation input signal AIS as the first multiplexed signal AIS1. Thus, the first multiplexed signal AIS1 represents ‘a’. The seventh multiplexer M7 selects and outputs, based on the mode signal M0, the fourth constant signal N4 as the second multiplexed signal AIS2. Thus, the second multiplexed signal AIS2 represents ‘0’. The eighth multiplexer M8 selects and outputs, based on the second processed signal P2, one of the first and second multiplexed signals MS1 and MS2 as the functional output signal FS. When the second processed signal P2 is generated at logic low state, the eighth multiplexer M8 selects and outputs the first multiplexed signal AIS1 as the functional output signal FS. Thus, the functional output signal FS represents ‘a’. When the second processed signal P2 is generated at logic high state, the eighth multiplexer M8 selects and outputs the second multiplexed signal AIS2 as the functional output signal FS. Thus, the functional output signal FS represents ‘0’. Thus, the processor 202 and the selection circuit 204 collectively execute the ReLU function.

When the mode signal M0 is ‘100’, the activation circuit 104 executes the PReLU function. The PReLU function is represented by an equation (7) given below:

$$PReLU ( a ) = \{ \begin{matrix}- α * abs ( a ) , & a < 0 \\ a , a \geq 0 & \end{matrix} \} \qquad ( 7 )$$

To execute the PReLU function, the first and second processing circuits 206a and 206b receive the activation input signal AIS and generate the first and second processed signals P1 and P2, respectively. Thus, the first processed signal P1 represents ‘abs(a)’. The first multiplexer M1 selects and outputs, based on the mode signal M0, the first constant signal N1 as the first control signal C1. The third processing circuit 206c receives the first processed signal P1 and the first control signal C1, and generates the third processed signal P3. The fourth processing circuit 206d receives the third processed signal P3 and generates the fourth processed signal P4. The fifth processing circuit 206e receives the fourth processed signal P4 and generates the fifth processed signal P5.

The fourth multiplexer M4 selects and outputs, based on the mode signal M0, the third constant signal N3 as the fourth control signal C4. Thus, the fourth control signal C4 represents ‘a’. The fifth multiplexer M5 selects and outputs, based on the mode signal M0, the first processed signal P1 as the fifth control signal C5. Thus, the fifth control signal C5 represents ‘abs(a)’. The seventh processing circuit 206g receives the fourth and fifth control signals C4 and C5 and generates the seventh processed signal P7 such that the seventh processed signal P7 represents ‘α*abs(a)’.

The second multiplexer M2 selects and outputs, based on the mode signal M0, the bitwise inverted version of the seventh processed signal P7 as the second control signal C2. As the second multiplexer M2 receives the seventh processed signal P7 at the inverting terminal of the second multiplexer M2, the second control signal C2 represents ‘α*abs(a)’. The third multiplexer M3 selects and outputs, based on the mode signal M0, the second constant signal N2 as the third control signal C3. Thus, the third control signal C3 represents ‘1’. The sixth processing circuit 206f receives the second and third control signals C2 and C3 and generates the sixth processed signal P6 such that the sixth processed signal P6 represents ‘−α*abs(a)’.

The sixth multiplexer M6 selects and outputs, based on the mode signal M0, the activation input signal AIS as the first multiplexed signal AIS1. Thus, the first multiplexed signal AIS1 represents ‘α’. The seventh multiplexer M7 selects and outputs, based on the mode signal M0, the sixth processed signal P6 as the second multiplexed signal AIS2. Thus, the second multiplexed signal AIS2 represents ‘−α*abs(a)’. The eighth multiplexer M8 selects and outputs, based on the second processed signal P2, one of the first and second multiplexed signals MS1 and MS2 as the functional output signal FS. When the second processed signal P2 is generated at logic low state, the eighth multiplexer M8 selects and outputs the first multiplexed signal AIS1 as the functional output signal FS. Thus, the functional output signal FS represents ‘a’. When the second processed signal P2 is generated at logic high state, the eighth multiplexer M8 selects and outputs the second multiplexed signal AIS2 as the functional output signal FS. Thus, the functional output signal FS represents ‘−α*abs(a)’. Thus, the processor 202 and the selection circuit 204 collectively execute the PReLU function.

When the mode signal M0 is ‘101’, the activation circuit 104 executes the ELU function. The ELU function is represented by an equation (8) given below:

$$ELU ( a ) = \{ \begin{matrix}- α * ( 1 - {e}^{- ab s ( a )} ) , & a < 0 \\ a , a \geq 0 & \end{matrix} \} \qquad ( 8 )$$

To execute the ELU function, the first and second processing circuits 206a and 206b receive the activation input signal AIS and generate the first and second processed signals P1 and P2, respectively. Thus, the first processed signal P1 represents ‘abs(a)’. The first multiplexer M1 selects and outputs, based on the mode signal M0, the first processed signal P1 as the first control signal C1. Thus, the first control signal C1 represents ‘abs(a)’. The third processing circuit 206c receives the first processed signal P1 and the first control signal C1, and generates the third processed signal P3 such that the third processed signal P3 represents ‘e^{-abs(a)}’. The fourth processing circuit 206d receives the third processed signal P3 and generates the fourth processed signal P4 such that the fourth processed signal P4 represents ‘(1+e^{-abs(a)})/2’. The fifth processing circuit 206e receives the fourth processed signal P4 and generates the fifth processed signal P5 such that the fifth processed signal P5 represents ‘2/(1+e^{-abs(a)})’.

The fourth multiplexer M4 selects and outputs, based on the mode signal M0, the third constant signal N3 as the fourth control signal C4. Thus, the fourth control signal C4 represents ‘α’. The fifth multiplexer M5 selects and outputs, based on the mode signal M0, the bitwise inverted version of the third processed signal P3 as the fifth control signal C5. As the fifth multiplexer M5 receives the third processed signal P3 at the inverting terminal of the fifth multiplexer M5, the fifth control signal C5 represents ‘1−e^{-abs(a)}’. The seventh processing circuit 206g receives the fourth and fifth control signals C4 and C5 and generates the seventh processed signal P7 such that the seventh processed signal P7 represents ‘α*(1−e^{-abs(a)})’.

The second multiplexer M2 selects and outputs, based on the mode signal M0, the bitwise inverted version of the seventh processed signal P7 as the second control signal C2. As the second multiplexer M2 receives the seventh processed signal P7 at the inverting terminal of the second multiplexer M2, the second control signal C2 represents ‘−α*(1−e^{-abs(a)})’. The third multiplexer M3 selects and outputs, based on the mode signal M0, the second constant signal N2 as the third control signal C3. Thus, the third control signal C3 represents ‘1’. The sixth processing circuit 206f receives the second and third control signals C2 and C3 and generates the sixth processed signal P6 such that the sixth processed signal P6 represents ‘−α*(1−e^{-abs(a)})’.

The sixth multiplexer M6 selects and outputs, based on the mode signal M0, the activation input signal AIS as the first multiplexed signal AIS1. Thus, the first multiplexed signal AIS1 represents ‘a’. The seventh multiplexer M7 selects and outputs, based on the mode signal M0, the sixth processed signal P6 as the second multiplexed signal AIS2. Thus, the second multiplexed signal AIS2 represents ‘−α*(1−e^{-abs(a)})’. The eighth multiplexer M8 selects and outputs, based on the second processed signal P2, one of the first and second multiplexed signals MS1 and MS2 as the functional output signal FS. When the second processed signal P2 is generated at logic low state, the eighth multiplexer M8 selects and outputs the first multiplexed signal AIS1 as the functional output signal FS. Thus, the functional output signal FS represents ‘a’. When the second processed signal P2 is generated at logic high state, the eighth multiplexer M8 selects and outputs the second multiplexed signal AIS2 as the functional output signal FS. Thus, the functional output signal FS represents ‘−α*(1−e^{-abs(a)})’. Thus, the processor 202 and the selection circuit 204 collectively execute the ELU function.

When the mode signal M0 is ‘110’, the activation circuit 104 executes the gaussian function. The gaussian function is represented by an equation (9) given below:

$$Gaussian ( a ) = \{ \begin{matrix}{e}^{- a b {s ( a )}^{2}} , & a < 0 \\ {e}^{- a b {s ( a )}^{2}} , & a \geq 0\end{matrix} \} \qquad ( 9 )$$

To execute the gaussian function, the first and second processing circuits 206a and 206b receive the activation input signal AIS and generate the first and second processed signals P1 and P2, respectively. Thus, the first processed signal P1 represents ‘abs(a)’. The second and third multiplexers M2 and M3 select and output, based on the mode signal M0, the first constant signal N1 as the second and third control signals C2 and C3, respectively. The sixth processing circuit 206f receives the second and third control signals C2 and C3 and generates the sixth processed signal P6.

The fourth and fifth multiplexers M4 and M5 select and output, based on the mode signal M0, the first processed signal P1 as the fourth and fifth control signals C4 and C5, respectively. Thus, the fourth and fifth control signals C4 and C5 represents ‘abs(a)’. The seventh processing circuit 206g receives the fourth and fifth control signals C4 and C5 and generates the seventh processed signal P7 such that the seventh processed signal P7 represents ‘abs(a)²’.

The first multiplexer M1 selects and outputs, based on the mode signal M0, the seventh processed signal P7 as the first control signal C1. Thus, the first control signal C1 represents ‘abs(a)²’. The third processing circuit 206c receives the first processed signal P1 and the first control signal C1, and generates the third processed signal P3 such that the third processed signal P3 represents ‘e^{-abs(a)\hat{ }2}’. The fourth processing circuit 206d receives the third processed signal P3 and generates the fourth processed signal P4. The fifth processing circuit 206e receives the fourth processed signal P4 and generates the fifth processed signal P5.

The sixth and seventh multiplexers M6 and M7 select and output, based on the mode signal M0, the third processed signal P3 as the first and second multiplexed signals MS1 and MS2, respectively. Thus, the first and second multiplexed signals MS1 and MS2 represent ‘e^{-abs(a)\hat{ }2}’. The eighth multiplexer M8 selects and outputs, based on the second processed signal P2, one of the first and second multiplexed signals MS1 and MS2 as the functional output signal FS. In either case, the functional output signal FS represents ‘e^{-abs(a)\hat{ }2}’. Thus, the processor 202 and the selection circuit 204 collectively execute the gaussian function.

FIG. 3 is a schematic block diagram of the activation circuit 104 in accordance with another embodiment of the present disclosure. The activation circuit 104 includes a signal generator 302, the processor 202, and the selection circuit 204.

The signal generator 302 is coupled with the configuration circuit 108, and configured to receive the mode signal M0 and decode the mode signal M0 to generate a plurality of select signals of which first through seventh select signals S1-S7 are shown.

The processor 202 includes the first through seventh processing circuits 206a-206g. The processor 202 functions in a similar manner as described in FIG. 2. The selection circuit 204 is coupled with the processor 202.

The selection circuit 204 is coupled with the signal generator 302 and further configured to provide, based on a first set of select signals S1-S5, i.e., the first through fifth select signals S1-S5, of the plurality of select signals, the plurality of control signals C1-C5 to the processor 202 (i.e., the third, sixth, and seventh processing circuits 206c, 206f, and 206g). Further, the selection circuit 204 is configured to output, based on a second set of select signals S6 and S7, i.e., the sixth and seventh select signals S6 and S7, of the plurality of select signals and the execution of each activation function of the plurality of activation functions, the functional output signal FS. The selection circuit 204 includes the first plurality of multiplexers 208a, the second plurality of multiplexers 208b, and the eighth multiplexer M8.

The first plurality of multiplexers 208a are configured to receive the first set of select signals S1-S5 and at least one of the activation input signal AIS, the first subset of processed signals P1, P3, P5, and P7, the modified second subset of processed signals LP1, RP3, RP5, and RP7, and the first subset of constant signals N1-N3. Further, the first plurality of multiplexers 208a are configured to output, based on the first through fifth select signals S1-S5, the plurality of control signals C1-C5.

The first multiplexer M1 is coupled with the signal generator 302 and the first and seventh processing circuits 206a and 206g, and configured to receive the first select signal S1, the first processed signal P1, the left-shifted first processed signal LP1, the first constant signal N1, and the seventh processed signal P7. The first multiplexer M1 receives the first processed signal P1, the left-shifted first processed signal LP1, the first constant signal N1, and the seventh processed signal P7 at the non-inverting input terminals thereof, and the first select signal S1 at the select terminal thereof. Based on the first select signal S1, the first multiplexer M1 is further configured to select and output one of the first processed signal P1, the left-shifted first processed signal LP1, the first constant signal N1, and the seventh processed signal P7 as the first control signal C1 at the output terminal thereof. The first multiplexer M1 is further coupled with the third processing circuit 206c, and further configured to provide the first control signal C1 to the third processing circuit 206c.

The second multiplexer M2 is coupled with the signal generator 302 and the seventh processing circuit 206g, and configured to receive the second select signal S2, the right-shifted fifth processed signal RP5, the right-shifted seventh processed signal RP7, the seventh processed signal P7, and the first constant signal N1. The second multiplexer M2 receives the right-shifted seventh processed signal RP7 and the first constant signal N1 at the non-inverting input terminals thereof, and the second select signal S2 at the select terminal thereof. Further, the second multiplexer M2 receives the right-shifted fifth processed signal RP5 and the seventh processed signal P7 at the inverting input terminals thereof such that the second multiplexer M2 thus receives the bitwise inverted version of the right-shifted fifth processed signal RP5 and the seventh processed signal P7. Based on the second select signal S2, the second multiplexer M2 is further configured to select and output one of the bitwise inverted version of the right-shifted fifth processed signal RP5, the bitwise inverted version of the right-shifted seventh processed signal RP7, the seventh processed signal P7, and the first constant signal N1 as the second control signal C2 at the output terminal thereof. The second multiplexer M2 is further coupled with the sixth processing circuit 206f, and further configured to provide the second control signal C2 to the sixth processing circuit 206f

The third multiplexer M3 is coupled with the signal generator 302, and configured to receive the third select signal S3, the activation input signal AIS, and the first and second constant signals N1 and N2. The third multiplexer M3 receives the activation input signal AIS and the first and second constant signals N1 and N2 at the non-inverting input terminals thereof, and the third select signal S3 at the select terminal thereof. Based on the third select signal S3, the third multiplexer M3 is further configured to select and output one of the activation input signal AIS and the first and second constant signals N1 and N2 as the third control signal C3 at the output terminal thereof. The third multiplexer M3 is further coupled with the sixth processing circuit 206f, and further configured to provide the third control signal C3 to the sixth processing circuit 206f

The fourth multiplexer M4 is coupled with the signal generator 302 and the first and fifth processing circuits 206a and 206e, and configured to receive the fourth select signal S4, the first and fifth processed signals P1 and P5, and the first and third constant signals N1 and N3. The fourth multiplexer M4 receives the first and fifth processed signals P1 and P5 and the first and third constant signals N1 and N3 at the non-inverting input terminals thereof, and the fourth select signal S4 at the select terminal thereof. Based on the fourth select signal S4, the fourth multiplexer M4 is further configured to select and output one of the first and fifth processed signals P1 and P5 and the first and third constant signals N1 and N3 as the fourth control signal C4 at the output terminal thereof. The fourth multiplexer M4 is further coupled with the seventh processing circuit 206g, and further configured to provide the fourth control signal C4 to the seventh processing circuit 206g.

The fifth multiplexer M5 is coupled with the signal generator 302 and the first and third processing circuits 206a and 206c, and configured to receive the fifth select signal S5, the first and third processed signals P1 and P3, the right-shifted third processed signal RP3, and the first constant signal N1. The fifth multiplexer M5 receives the first processed signal P1 and the first constant signal N1 at the non-inverting input terminals thereof, and the fifth select signal S5 at the select terminal thereof. Further, the fifth multiplexer M5 receives the third processed signal P3 and the right-shifted third processed signal RP3 at the inverting input terminals thereof such that the fifth multiplexer M5 receives the bitwise inverted version of the third processed signal P3 and the right-shifted third processed signal RP3. Based on the fifth select signal S5, the fifth multiplexer M5 is further configured to select and output one of the first processed signal P1, the bitwise inverted version of the third processed signal P3, the bitwise inverted version of the right-shifted third processed signal RP3, and the first constant signal N1 as the fifth control signal C5 at the output terminal thereof. The fifth multiplexer M5 is further coupled with the seventh processing circuit 206g, and further configured to provide the fifth control signal C5 to the seventh processing circuit 206g.

The second plurality of multiplexers 208b are configured to receive the second set of select signals S6 and S7 and at least one of the activation input signal AIS, the third subset of processed signals P3, P6, and P7, the modified fourth subset of processed signals RP5 and RP7, and the second subset of constant signals N1 and N4. The second plurality of multiplexers 208b are further configured to output, based on the second set of select signals S6 and S7, the plurality of multiplexed signals, such as the first and second multiplexed signals MS1 and MS2.

The sixth multiplexer M6 is coupled with the signal generator 302 and the third and seventh processing circuits 206c and 206g, and configured to receive the sixth select signal S6, the activation input signal AIS, the third and seventh processed signals P3 and P7, the right-shifted fifth processed signal RP5, the right-shifted seventh processed signal RP7, and the first constant signal N1. The sixth multiplexer M6 receives the activation input signal AIS, the third and seventh processed signals P3 and P7, the right-shifted fifth processed signal RP5, the right-shifted seventh processed signal RP7, and the first constant signal N1 at the non-inverting input terminals thereof, and the sixth select signal S6 at the select terminal thereof. Based on the sixth select signal S6, the sixth multiplexer M6 is further configured to select and output one of the activation input signal AIS, the third and seventh processed signals P3 and P7, the right-shifted fifth processed signal RP5, the right-shifted seventh processed signal RP7, and the first constant signal N1 as the first multiplexed signal AIS1 at the output terminal thereof. The sixth multiplexer M6 is further coupled with the eighth multiplexer M8, and further configured to provide the first multiplexed signal AIS1 to the eighth multiplexer M8.

The seventh multiplexer M7 is coupled with the signal generator 302 and the third and sixth processing circuits 206c and 206f, and configured to receive the seventh select signal S7, the third and sixth processed signals P3 and P6, and the first and fourth constant signals N1 and N4. The seventh multiplexer M7 receives the third and sixth processed signals P3 and P6 and the first and fourth constant signals N1 and N4 at the non-inverting input terminals thereof, and the seventh select signal S7 at the select terminal thereof. Based on the seventh select signal S7, the seventh multiplexer M7 is further configured to select and output one of the third and sixth processed signals P3 and P6, and the first and fourth constant signals N1 and N4 as the second multiplexed signal AIS2 at the output terminal thereof. The seventh multiplexer M7 is further coupled with the eighth multiplexer M8, and further configured to provide the second multiplexed signal AIS2 to the eighth multiplexer M8.

The eighth multiplexer M8 is coupled with the second plurality of multiplexers 208b (i.e., the sixth and seventh multiplexers M6 and M7) and the second processing circuit 206b, and configured to receive the plurality of multiplexed signals (i.e., the first and second multiplexed signals MS1 and MS2) and the second processed signal P2. The eighth multiplexer M8 receives the first and second multiplexed signals MS1 and MS2 at the non-inverting input terminals thereof, and the second processed signal P2 at the select terminal thereof. Based on the second processed signal P2, the eighth multiplexer M8 is further configured to select and output one of the first and second multiplexed signals MS1 and MS2 as the functional output signal FS at the output terminal thereof. In one embodiment, each of the first, second, fourth, fifth, and seventh multiplexers M1, M2, M4, M5, and M7 is a 4:1 multiplexer, the third multiplexer M3 is a 3:1 multiplexer, the sixth multiplexer M6 is a 6:1 multiplexer, and the eighth multiplexer M8 is a 2:1 multiplexer.

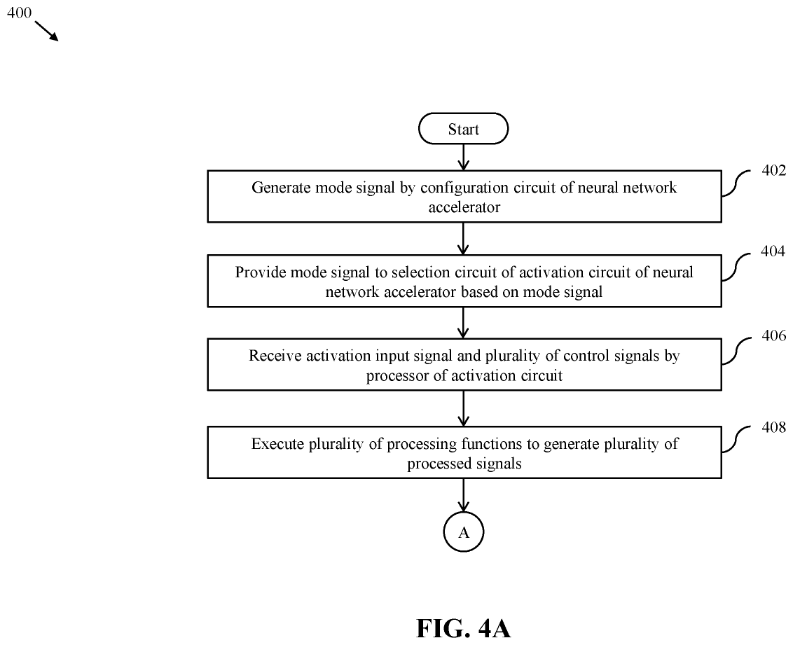

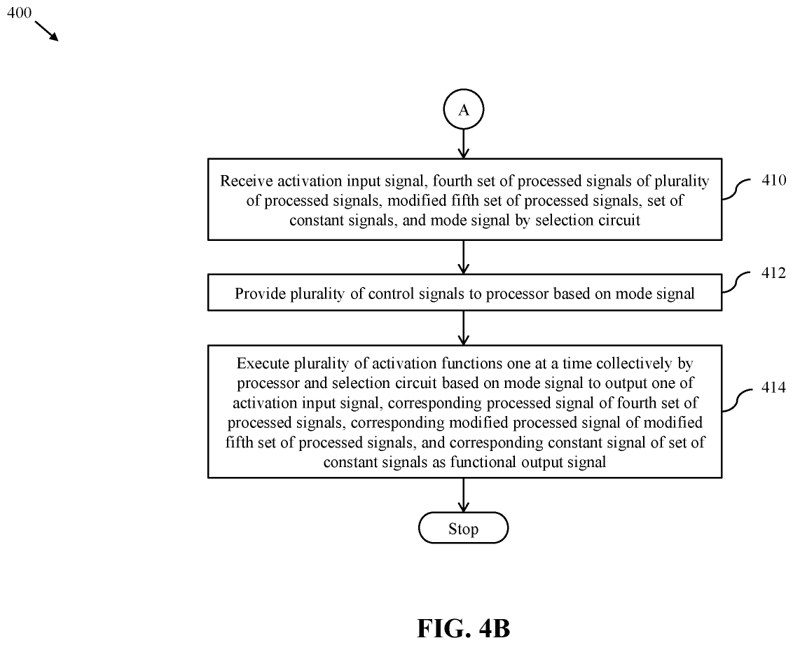

FIGS. 4A and 4B, collectively, represent a flow chart 400 that illustrates a method of executing the plurality of activation functions by the neural network accelerator 100 in accordance with an embodiment of the present disclosure.

At step 402, the configuration circuit 108 generates the mode signal M0. At step 404, the configuration circuit 108 provides the mode signal M0 to the selection circuit 204. At step 406, the processor 202 receives the activation input signal AIS and the plurality of control signals C1-C5. At step 408, the processor 202 executes, based on the activation input signal AIS and the plurality of control signals C1-C5, the plurality of processing functions to generate the plurality of processed signals P1-P7. The generation of the plurality of processed signals P1-P7 has been explained in detail in FIG. 2.

At step 410, the selection circuit 204 receives the activation input signal AIS, the fourth set of processed signals P1-P3 and P5-P7, the modified fifth set of processed signals LP1, RP3, RP5, and RP7, the set of constant signals N1-N4, and the mode signal M0. At step 412, the selection circuit 204 provides, based on the mode signal M0, the plurality of control signals C1-C5 to the processor 202.

At step 414, the processor 202 and the selection circuit 204 collectively execute, based on the mode signal M0, each activation function of the plurality of activation functions one at a time to output one of the activation input signal AIS, a corresponding processed signal of the fourth set of processed signals P1-P3 and P5-P7, a corresponding modified processed signal of the modified fifth set of processed signals LP1, RP3, RP5, and RP7, and a corresponding constant signal of the set of constant signals N1-N4 as the functional output signal FS. The execution of each activation function has been explained in detail in FIG. 2.

The activation circuit 104 of the neural network accelerator 100 is capable of executing each activation function associated with the neural network accelerator 100 one at a time, based on the mode signal M0. As the same activation circuit 104 is capable of executing different activation functions, a need of various activation circuits to execute different activation functions in the neural network accelerator 100 is eliminated. As a result, a size and a power consumption of the neural network accelerator 100 is significantly low than a conventional neural network accelerator that utilizes multiple activation circuits to execute various activation functions.

Although the disclosure is described herein with reference to specific embodiments, various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure. Any benefits, advantages, or solutions to problems that are described herein with regard to specific embodiments are not intended to be construed as a critical, required, or essential feature or element of any or all the claims.

The term “coupled,” as used herein, is not intended to be limited to a direct coupling or a mechanical coupling.

Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to disclosures containing only one such element, even when the same claim includes the introductory phrases “one or more” or “at least one” and indefinite articles such as “a” or “an.” The same holds true for the use of definite articles.

Unless stated otherwise, terms such as “first” and “second” are used to arbitrarily distinguish between the elements such terms describe. Thus, these terms are not necessarily intended to indicate temporal or other prioritization of such elements.

1. A neural network accelerator, comprising:
an activation circuit comprising:
a processor that is configured to execute a plurality of processing functions to generate a plurality of processed signals; and
a selection circuit that is coupled with the processor, wherein the selection circuit and the processor are collectively configured to execute each activation function of a plurality of activation functions one at a time, wherein the execution of each activation function corresponds to the execution of at least one processing function of the plurality of processing functions, and wherein to execute each activation function, the selection circuit is further configured to:
receive a first input signal, a first set of processed signals of the plurality of processed signals, a modified second set of processed signals, a set of constant signals, and a mode signal, wherein the mode signal indicates an activation function of the plurality of activation functions that is to be executed; and
output, based on the mode signal, one of the first input signal, a first processed signal of the first set of processed signals, a modified second processed signal of the modified second set of processed signals, and a first constant signal of the set of constant signals as a functional output signal.

2. The neural network accelerator of claim 1, wherein to execute the activation function, the selection circuit is further configured to provide, based on the mode signal, a plurality of control signals to the processor, and wherein each control signal is one of the first input signal, a third processed signal of the first set of processed signals, a modified fourth processed signal of the modified second set of processed signals, and a second constant signal of the set of constant signals.

3. The neural network accelerator of claim 2, wherein the processor comprises a plurality of processing circuits, and wherein (i) a first set of processing circuits of the plurality of processing circuits is configured to receive the first input signal, and execute a first set of processing functions of the plurality of processing functions to generate a third set of processed signals of the plurality of processed signals, (ii) a second set of processing circuits of the plurality of processing circuits is configured to receive at least one of a corresponding processed signal of the plurality of processed signals and a first set of control signals of the plurality of control signals, and execute a second set of processing functions of the plurality of processing functions to generate a fourth set of processed signals of the plurality of processed signals, and (iii) a third set of processing circuits of the plurality of processing circuits is configured to receive a second set of control signals of the plurality of control signals, and execute a third set of processing functions of the plurality of processing functions to generate a fifth set of processed signals of the plurality of processed signals.

4. The neural network accelerator of claim 2, wherein the selection circuit comprises a first plurality of multiplexers, and wherein the first plurality of multiplexers are configured to:
receive the mode signal and at least one of the first input signal, a first subset of processed signals of the first set of processed signals, a modified second subset of processed signals of the modified second set of processed signals, and a first subset of constant signals of the set of constant signals, wherein each modified processed signal of the modified second subset of processed signals corresponds to one of a left-shifted version of a corresponding processed signal of the first subset of processed signals and a right-shifted version of the corresponding processed signal; and
output, based on the mode signal, the plurality of control signals, wherein the first subset of processed signals includes the third processed signal, the modified second subset of processed signals includes the modified fourth processed signal, and the first subset of constant signals includes the second constant signal.

5. The neural network accelerator of claim 1, wherein the selection circuit comprises a second plurality of multiplexers, and wherein the second plurality of multiplexers are configured to:
receive the mode signal and at least one of the first input signal, a third subset of processed signals of the first set of processed signals, a modified fourth subset of processed signals of the modified second set of processed signals, and a second subset of constant signals of the set of constant signals, wherein each modified processed signal of the modified fourth subset of processed signals corresponds to a right-shifted version of a corresponding processed signal of a fifth subset of processed signals of the first set of processed signals; and
output, based on the mode signal, a plurality of multiplexed signals, wherein each multiplexed signal of the plurality of multiplexed signals is one of the first input signal, the first processed signal of the third subset of processed signals, the modified second processed signal of the modified fourth subset of processed signals, and the first constant signal of the second subset of constant signals.

6. The neural network accelerator of claim 5, wherein the selection circuit further comprises a third multiplexer that is coupled with the second plurality of multiplexers, and configured to receive the plurality of multiplexed signals and a fifth processed signal of the plurality of processed signals, and select and output, based on the fifth processed signal, a first multiplexed signal of the plurality of multiplexed signals as the functional output signal.

7. The neural network accelerator of claim 1, wherein the plurality of processing functions include at least one of an absolute value function, an exponential function, a ternary arithmetic function, a division function, an addition function, a multiplication function, and a sign function.

8. The neural network accelerator of claim 1, wherein the plurality of activation functions include at least a sigmoid function, a hyperbolic tangent function, a swish function, a rectified linear unit function, a parametric rectified linear unit function, an exponential linear unit function, and a gaussian function.

9. The neural network accelerator of claim 1, further comprising a multiply and accumulate (MAC) circuit that is coupled with the activation circuit, and configured to receive a second plurality of input signals, execute a MAC operation on the second plurality of input signals to generate the first input signal, and provide the first input signal to the activation circuit.

10. The neural network accelerator of claim 1, further comprising a controller that is coupled with the activation circuit, and configured to receive the functional output signal and generate a feature map based on the functional output signal.

11. The neural network accelerator of claim 1, further comprising a configuration circuit that is coupled with the activation circuit, and configured to generate and provide the mode signal to the activation circuit.

12. A method of executing a plurality of activation functions by a neural network accelerator, the method comprising:
executing, by a processor of an activation circuit of the neural network accelerator, a plurality of processing functions to generate a plurality of processed signals;
receiving, by a selection circuit of the activation circuit, an input signal, a first set of processed signals of the plurality of processed signals, a modified second set of processed signals, a set of constant signals, and a mode signal; and
executing, collectively by the processor and the selection circuit based on the mode signal, each activation function of the plurality of activation functions one at a time to output one of the input signal, a first processed signal of the first set of processed signals, a modified second processed signal of the modified second set of processed signals, and a first constant signal of the set of constant signals as a functional output signal, wherein the execution of each activation function corresponds to the execution of at least one processing function of the plurality of processing functions, and wherein the mode signal indicates an activation function of the plurality of activation functions that is to be executed.

13. The method of claim 12, further comprising providing, by the selection circuit, based on the mode signal, a plurality of control signals to the processor, wherein each control signal of the plurality of control signals is one of the input signal, a third processed signal of the first set of processed signals, a modified fourth processed signal of the modified second set of processed signals, and a second constant signal of the set of constant signals.

14. The method of claim 12, wherein the plurality of processing functions include at least one of an absolute value function, an exponential function, a ternary arithmetic function, a division function, an addition function, a multiplication function, and a sign function, and wherein the plurality of activation functions include at least a sigmoid function, a hyperbolic tangent function, a swish function, a rectified linear unit function, a parametric rectified linear unit function, an exponential linear unit function, and a gaussian function.

15. The method of claim 12, further comprising:
generating, by a configuration circuit of the neural network accelerator, the mode signal; and
providing, by the configuration circuit, the mode signal to the selection circuit.

16. An activation circuit of a neural network accelerator, comprising:
a signal generator that is configured to receive a mode signal and decode the mode signal to generate a plurality of select signals, wherein the mode signal indicates execution of an activation function of a plurality of activation functions;
a processor that is configured to execute a plurality of processing functions to generate a plurality of processed signals; and
a selection circuit that is coupled with the processor and the signal generator, wherein the selection circuit and the processor are collectively configured to execute each activation function of the plurality of activation functions one at a time, wherein the execution of each activation function corresponds to the execution of at least one processing function of the plurality of processing functions, and wherein to execute each activation function of the plurality of activation functions, the selection circuit is further configured to:
receive an input signal, a first set of processed signals of the plurality of processed signals, a modified second set of processed signals, a set of constant signals, and the plurality of select signals; and
output, based on a first set of select signals of the plurality of select signals, one of the input signal, a first processed signal of the first set of processed signals, a modified second processed signal of the modified second set of processed signals, and a first constant signal of the set of constant signals as a functional output signal.

17. The activation circuit of claim 16, wherein the selection circuit is further configured to provide, based on a second set of select signals of the plurality of select signals, a plurality of control signals to the processor, and wherein each control signal of the plurality of control signals is one of the input signal, a third processed signal of the first set of processed signals, a modified fourth processed signal of the modified second set of processed signals, and a second constant signal of the set of constant signals.

18. The activation circuit of claim 17, wherein the processor comprises a plurality of processing circuits, and wherein (i) a first set of processing circuits of the plurality of processing circuits is configured to receive the input signal, and execute a first set of processing functions of the plurality of processing functions to generate a third set of processed signals of the plurality of processed signals, (ii) a second set of processing circuits of the plurality of processing circuits is configured to receive at least one of a corresponding processed signal of the plurality of processed signals and a first set of control signals of the plurality of control signals, and execute a second set of processing functions of the plurality of processing functions to generate a fourth set of processed signals of the plurality of processed signals, and (iii) a third set of processing circuits of the plurality of processing circuits is configured to receive a second set of control signals of the plurality of control signals, and execute a third set of processing functions of the plurality of processing functions to generate a fifth set of processed signals of the plurality of processed signals.

19. The activation circuit of claim 16, wherein the plurality of processing functions include at least one of an absolute value function, an exponential function, a ternary arithmetic function, a division function, an addition function, a multiplication function, and a sign function.

20. The activation circuit of claim 16, wherein the plurality of activation functions include at least a sigmoid function, a hyperbolic tangent function, a swish function, a rectified linear unit function, a parametric rectified linear unit function, an exponential linear unit function, and a gaussian function.
